(19) United States
(12) Patent Application Publication
(10) Pub. No.: US 2011/0249709 A1
(43) Pub. Date: Oct. 13, 2011

(54) DHT-Based OFDM Transmitter and Receiver

(76) Inventors: Muh-Tian Shiue, Hsinchu City (TW); Chin-Kuo Jao, Miaoli City (TW); Syu-Siang Long, Pingzhen City (TW); Chin-Long Wey, Kaohsiung City (TW)

(21) Appl. No.: 12/756,232

(22) Filed: Apr. 8, 2010

(51) Int. Cl. H04B 1/38; H04L 27/36

(52) U.S. Cl. 375/219; 375/298; 375/320

(57) ABSTRACT

A DHT-based OFDM transmitter and receiver use discrete Hartley transform to implement multicarrier transmission. A transmission terminal (or a receiving terminal) of a transmitter and receiver comprises two IDHT (or DHT) processors and a diagonal processing device. The two IDHT processors make the DHT-OFDM system transmit the 2D modulation signal to increase the bandwidth efficiency. The diagonal processing device is used to diagonalize the circulant channel matrix into discrete memoryless subchannels, and thus only one-tap frequency domain equalizer can compensate the channel effects. Besides, the proposed DHT-OFDM transmitter and receiver are also compatible with a conventional DFT-OFDM system, and they can flexibly works with the conventional DFT-OFDM transmitter and receiver.

### BACKGROUND OF THE INVENTION

1. Field of the Invention

This invention relates to a transmitter and receiver and particularly to a DHT-based OFDM transmitter and receiver.

2. Description of the Related Art

The related characteristics of DHT matrix are summarized and then used to describe the technical problem that the conventional DHT-OFDM system confronts.

### Characteristics of the DHT Matrix

Firstly, the N×N matrices of DFT and DHT (or IDHT) may be expressed as:

$$F = \frac{1}{\sqrt{N}} ( C + j S ) and H = \frac{1}{\sqrt{N}} ( C + S ) \qquad ( 1 )$$

C(l,m)=cos(2πlm/N) and S(l,m)=sin(2πlm/N) are a sin matrix and a cosine matrix, respectively. From the symmetric characteristics of the trigonometric functions, J_{N}S=SJ_{N}=−S and J_{N}C=CJ_{N}=C can be obtained, in which J_{N} is a N×N permutation matrix and defined as follows:

$${J}_{N} = [ \begin{matrix}1 & 0 & Λ & Λ & 0 \\ 0 & & & N & 1 \\ M & & N & N & 0 \\ M & N & N & N & M \\ 0 & 1 & 0 & Λ & 0\end{matrix} ]$$

According to the characteristic of real-valued circulant matrix Ã that can be diagonalized by the DFT matrix F, an equation is obtained as follows:

$$Λ = {F}^{H} \tilde{A} F = \frac{1}{N} ( S \tilde{A} S + C \tilde{A} C ) + j ( C \tilde{A} S - S \tilde{A} C ) = diag \{ {λ}^{ρ} \} \qquad ( 2 )$$

To determine whether the circulant matrix is similarly diagonalized by the DHT matrix, the DFT matrix in equation (2) is replaced with the DHT matrix H to obtain the result as follows:

$$H \tilde{A} H = \frac{1}{N} ( C + S ) \tilde{A} ( C + S ) = \frac{1}{N} ( S \tilde{A} S + C \tilde{A} C + C \tilde{A} S + S \tilde{A} C ) \qquad ( 3 )$$

By applying the trigonometric properties to equation (3), CÃS+SÃC=J_{N}(CÃS+SÃC) is obtained. Thus, by using the result obtained from equation (2), equation (3) can be re-expressed as:

$$\begin{matrix}H \tilde{A} H = \{ Λ \} + {J}_{N} 𝒥 \{ Λ \} \\ = [ \begin{matrix} \{ {λ}_{0} \} & 0 & Λ & Λ & 0 \\ 0 & \{ {λ}_{1} \} & & & 𝒥 \{ {λ}_{N - 1} \} \\ M & & O & N & \\ M & & N & O & \\ 0 & 𝒥 \{ {λ}_{1} \} & & & \{ {λ}_{N - 1} \}\end{matrix} ]\end{matrix} \qquad ( 4 )$$

Equation (4) apparently shows that the entries ℑ{λ₁, λ₂, . . . , λ_{N-1}} exist on the anti-diagonal of the HAH matrix, which indicates that the DHT matrix cannot diagonalize the circulant matrix.

### Conventional 1D DHT-OFDM System

Refer to FIG. 5, a block diagram of a conventional one dimensional (1D) DHT-OFDM system is illustrated (digested from Reference 1, hereafter “R1”). Firstly, the bit stream is transmitted from a transmission terminal to a PAM mapper 50 to become transmitted data symbol. The data symbol in R1 must be a 1D constellation point, such as BPSK or PAM signaling. Each data symbol {dₖ} should be allocated on two mirror-symmetric subcarriers before feeding into the IDHT processor 70. The IDHT processor 70 is an inverse discrete Hartley transform to modulate the PAM symbol {dₖ} to the N orthogonal subcarriers. At the receiver, the received signal vector [symbol] processed by the DHT processor 71 are fed into the one-tap frequency domain equalizer (FEQ) 72 to compensate the channel effects. The DHT processor 71 is a discrete Hartley transform to demodulate each data symbol {dₖ} from the N orthogonal subcarriers. Actually, although DHT is different from IDHT in name, they are the same in the definition of mathematics and are denoted by matrix H. Since half of the data symbols on the mirror-symmetric subcarriers are redundant, they should be dropped before a PAM demapper.

The DHT-OFDM system proposed in R1 is not bandwidth-efficient because only 1D constellation symbol is employed. Therefore, another reference, (hereafter “R2”) proposed a 2D DHT-based OFDM system, of which a block diagram is shown in FIG. 6. To transmit the 2D data symbol, such as quadrature amplitude modulation (QAM), in R2, two IDHT devices 70 are used to perform multicarrier modulation in the transmitter. At the receiver, the in-phase and quadrature-phase data path are fed into two DHT processors 71 for demodulation. However, the data symbol on the mirror-symmetric subcarriers will interfere with each other because of the inherent properties of DHT. Therefore this type of DHT-OFDM system needs multi-tap FEQ 73 to compensate the frequency-selective channel fading.

FIGS. 5 and 6 are the block diagrams of DHT-OFDM system in the prior arts, R1 and R2. A signal vector [symbol] in the receiver terminal can be expressed as

[symbol]

=H(Ã_{R}+jÃ₁)H× [symbol] + [symbol] (5)

[symbol] (shown in FIG. 6) is an N×1 signal vector in the transmitter terminal, H is an IDHT or DHT matrix, and [symbol] is a noise vector. When the length of CP is larger than the length of multipath channel delay, the channel effect can be expressed as a complex circulant matrix Ã_{c}=Ã_{R}+jÃ₁. Equation (4) clearly shows that the DHT cannot diagonalize the circulant channel matrix, therefore equation (5) reveals that the receiver signal vector [symbol] will be interfered with the mirror-symmetric subcarriers; namely, the data symbol dᵢ on the i-th subcarrier interferes the symbol d_{N-i} on the (N−i)-th subcarrier, i=1, . . . , N/2−1. That is the reason why, in the prior art R1, half of the signal bandwidth is waste to transmit the repeated symbols for avoiding the inter-carrier interference caused by the channel effect. Besides, the other defect described in R1 is the fact that only the 1D modulation signal dᵢ, such as a BPSK or PAM signal, can be transmitted, which limits the bandwidth efficiency of the system. In the prior art R2, a multi-tap FEQ 73 is required to compensate the inter-carrier interference caused by the channel effect, which makes the system complexity increase.

The main reason why the prior arts exist those defects is the DHT cannot directly diagonalize the equivalent circulant channel matrix, so the mirror-symmetric subcarriers interfere with each other.

### SUMMARY OF THE INVENTION

To solve the problem mentioned above, the present invention provides a DHT-based OFDM transmitter and receiver architecture based on discrete Hartley transformation. The transmitter and receiver comprise two IDHT (or DHT) processors and one channel diagonalization processing device. The two IDHT processors make the DHT-OFDM system transmit the 2D modulation signal to increase the efficiency of bandwidth. The diagonalization processing device is used to perfectly diagonalize the equivalent circulant channel matrix into discrete memoryless subchannels, and thus only the simple one-tap FEQ is used to compensate the channel. Besides, the DHT-OFDM transmitter and receiver are also compatible with the conventional DFT-OFDM one and can flexibly work with the conventional DFT-OFDM transmitter and receiver.

### BRIEF DESCRIPTION OF THE DRAWINGS

FIG. 1 is a block diagram of a DHT-OFDM transmitter in an embodiment of this invention;

FIG. 2 is a block diagram of a DHT-OFDM receiver in an embodiment of this invention;

FIG. 3 is a block diagram of a combination of the DFT-OFDM transmitter and DHT-OFDM receiver in an embodiment of this invention;

FIG. 4 is a block diagram of a combination of the DHT-OFDM transmitter and DFT-OFDM receiver in an embodiment of this invention;

FIG. 5 is a block diagram of a conventional DHT-OFDM of 1D modulation; and

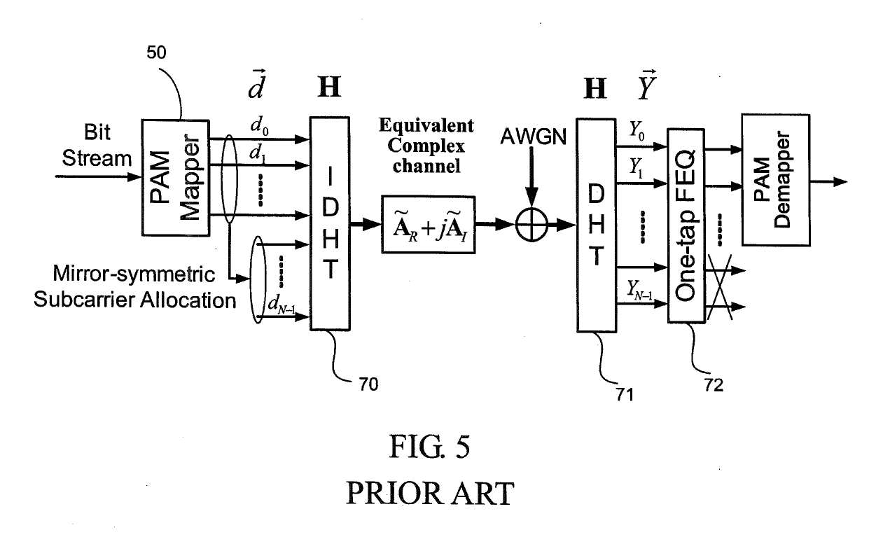

FIG. 6 is a block diagram of a conventional DHT-OFDM of 2D modulation.

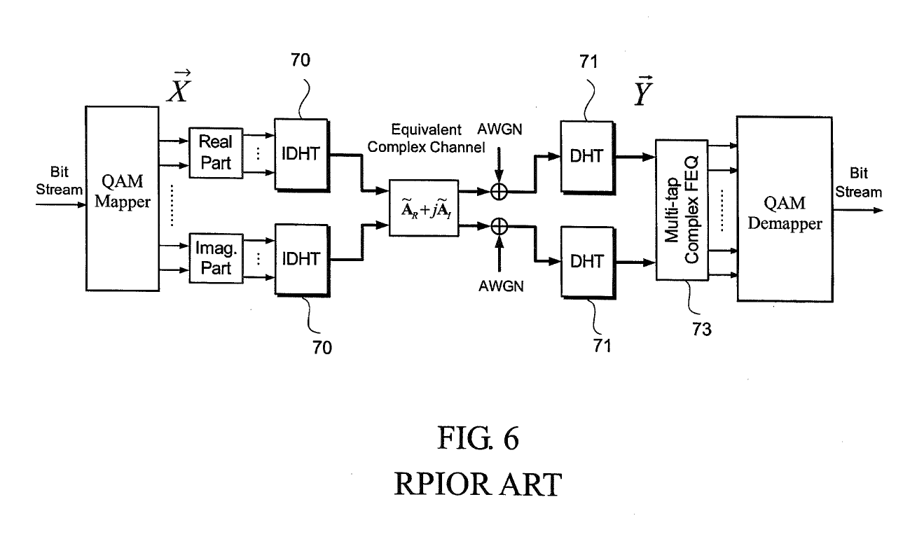

### DETAILED DESCRIPTION OF THE PREFERRED EMBODIMENTS

Now, the present invention will be described more specifically with reference to the following embodiments. It is to be noted that the following description of preferred embodiments of this invention is presented herein for the purpose of illustration and description only; it is not intended to be exhaustive or to be limited to the precise form disclosed.

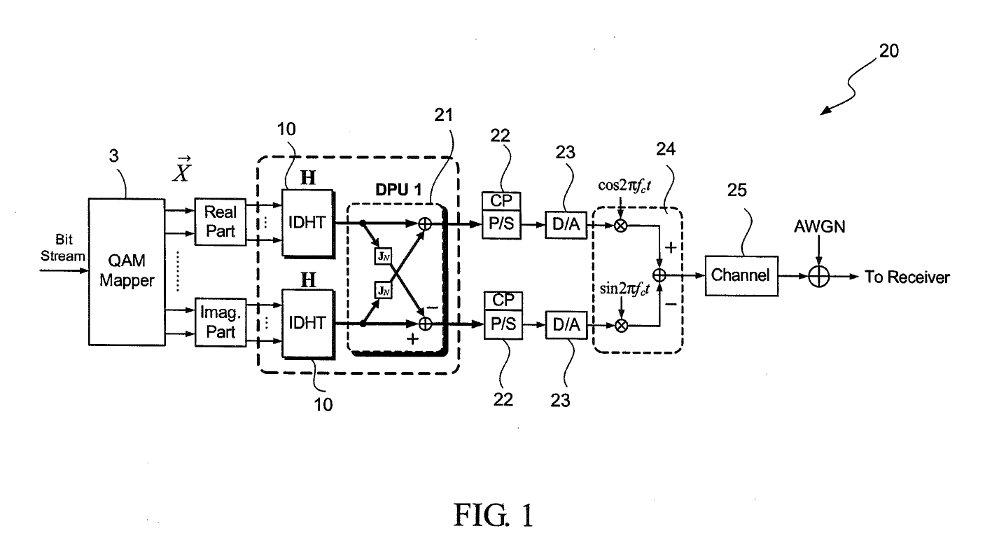

With reference to FIGS. 1 through 4 a DHT-based OFDM transmitter and receiver in this invention is illustrated. The OFDM transmitter is based on the discrete Hartley transform architecture, as shown in FIG. 1, and comprises a quadrature amplitude modulation (QAM) mapper 3, a multicarrier modulator, and a diagonal processing unit (DPU) 21. The QAM mapper 3 maps a bit stream to a 2D QAM signal vector [symbol] = [symbol] ^{R}+j [symbol] ¹. The DHT-based multicarrier modulator is connected to the QAM mapper 3. The multicarrier modulator generates a OFDM modulation signal. One terminal of the DPU 21 is connected to the multicarrier modulator. The DPU 21 comprises a component J_{N}. The component J_{N} arranges a signal vector element in a retrograde order.

The multicarrier modulator comprises two inverse discrete Hartley transform (IDHT) processors 10. The IDHT 10 modulate the 2D QAM signal vector [symbol] onto the N orthogonal subcarriers. Further, the diagonal processing unit (DPU) 21 is used to process IDHT output signal. Accompanying the proposed receiver design 30, the DPU can diagonalize the circulant channel matrix to avoid the mirror-symmetric inter-carrier interference. The other terminal of the DPU 21 is further connected to a terminal of a P/S and CP adding unit 22. The P/S and CP adding unit 22 means series-to-parallel conversion, which converts a parallel vector signal behind the DPU into a serial output. CP means Cyclic Prefix that is inserted before the serial output OFDM symbol. When the CP is inserted, the multipath channel matrix is equivalent to a circulant channel matrix.

The other terminal of the P/S and add C/P unit 22 is connected to a terminal of a D/A converter 23. The D/A converter 23 means a digital-to-analog converter, which converts a discrete digital signal into a continuous analog signal.

The other terminal of the D/A converter 23 is connected to a terminal of a transmitter RF circuit 24, and the other terminal of the transmitter RF circuit 24 is further connected to a multipath fading channel 25. The function of the transmitter RF circuit 24 is to modulate a baseband signal to a high frequency signal. When the CP is inserted in the OFDM system and removed in the receiver, the multipath fading channel 25 can be described as the circulant matrix.

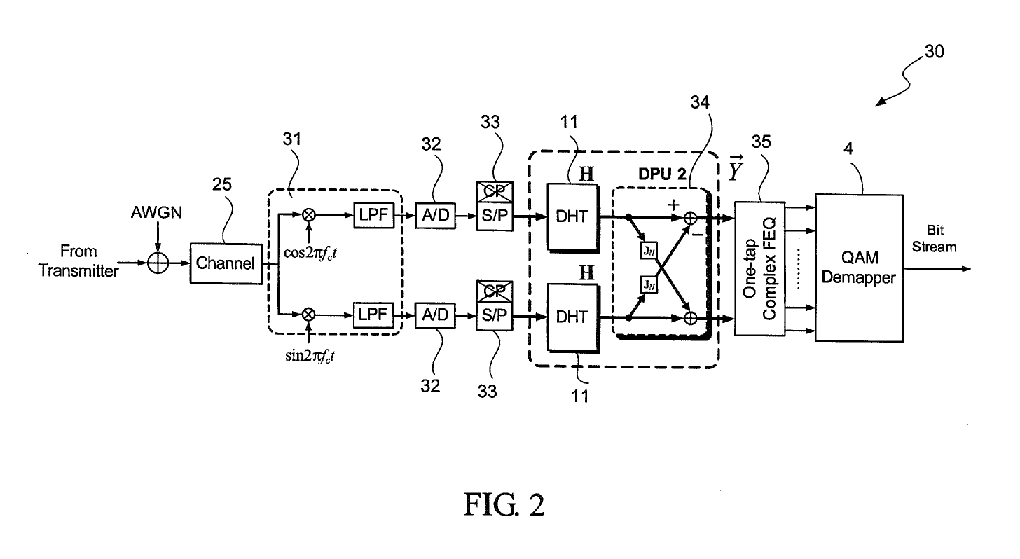

Further, the OFDM receiver is based on the discrete Hartley transform architecture, as shown in FIG. 2, and comprises a multicarrier demodulator 11, a DPU 34, a one-tap FEQ 35, and a QAM de-mapper 4. The multicarrier demodulator is used to demodulate the OFDM signal. The DPU 34 is connected to one terminal of the multicarrier demodulator. Accompanying the proposed DHT-based OFDM transmitter, the DPU 34 can diagonalize the circulant channel matrix. The one-tap FEQ 35 is connected to the DPU 34. The one-tap FEQ 35 is used to compensate the channel effects on each subcarriers. The QAM demapper 4 is connected to the one-tap FEQ 35. The QAM demapper 4 maps the compensated QAM symbol to bit stream The one-tap FEQ 35 is comprised by a complex multiplier. The proposed DHT-OFDM system can diagonalize the circulant channel matrix, so a complex multiplier is required on each subcarrier to compensate the channel effects. The coefficients of FEQ can be expressed as equation (11).

The multicarrier modulator comprises two discrete Hartley transform (DHT) processors 11. The function of the DHT 11 is to demodulate the QAM signal vector from the N orthogonal subcarriers. Along with the proposed transmitter architecture 20, the DPU 34 can diagonalize the circulant channel matrix to avoid the mirror-symmetric inter-carrier interference.

The other terminal of the multicarrier modulator is connected to a terminal of a S/P and CP removing unit 33. The S/P and CP removing unit 33 removes the CP of OFDM signal, converts a serial data sequence into a parallel signal vector, and transmits the parallel signal vector to the DHT 11.

The other terminal of the S/P and CP removing unit 33 is connected to a terminal of an A/D converter 32. The A/D converter 32 means an analog-to-digital (A/D) converter, and its function is to convert a continuous analog signal into a discrete digital signal.

The other terminal of A/D converter 32 is connected to a terminal of a receiver RF circuit 31. The receiver RF circuit 31 demodulates the high-frequency signal down to a baseband signal.

The other terminal of the receiver RF circuit 31 is connected to an attenuation channel 25.

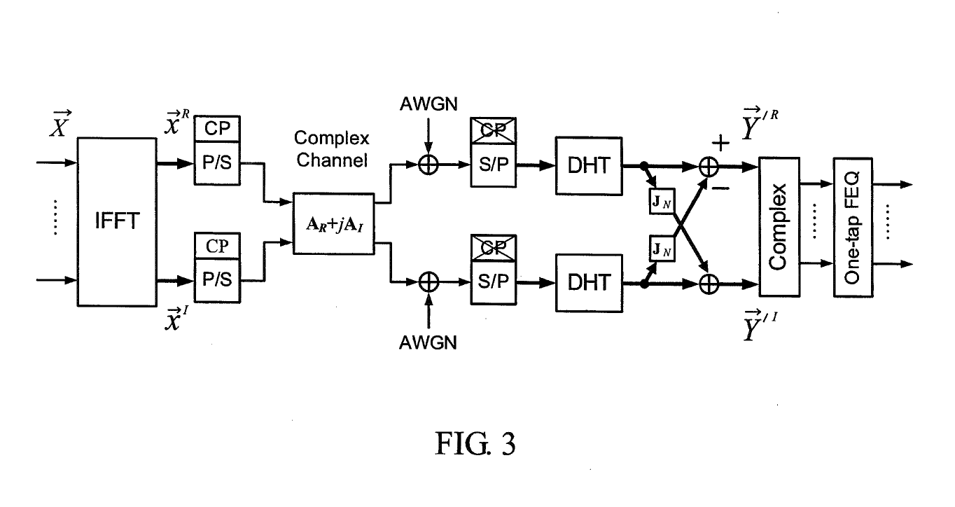

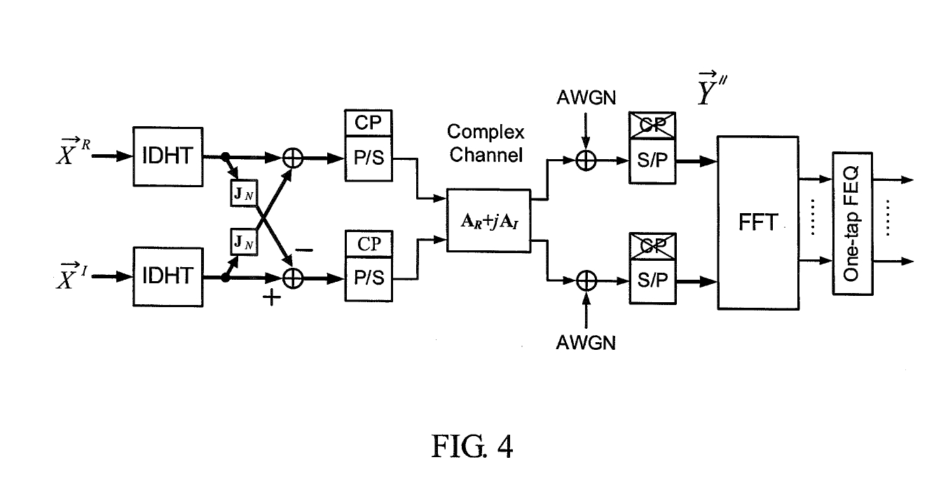

With reference to FIGS. 1 through 4, generally, the conventional OFDM is based on discrete Fourier transform (DFT) for achievement of multicarrier modulation, and thus the system is named a DFT-based OFDM system. When CP is inserted before the OFDM symbol, and the length of CP is larger than the length of multipath channel delay spread, the DFT-OFDM system can diagonalize the equivalent circulant channel matrix into the discrete memoryless subchannels. Thus, only one-tap FEQ can easily compensate the channel, which is the reason why the DFT-based OFDM system can mitigate the multipath channel fading. IFFT in FIG. 3 is an inverse fast Fourier transform; FFT in FIG. 4 is a fast Fourier transform. Different from the complex-valued operation of DFT, the DHT belongs to the transformation of real-valued operations, and thus the OFDM system based on DHT kernel has the advantages in computational complexity and implementation. However, due to the inherent properties of DHT, DHT-OFDM cannot perfectly diagonalize the circulant channel matrix as DFT-OFDM does even if the length of CP is larger than the length of multipath channel delay spread. If the circulant channel matrix cannot be diagonalized, the signals on the mirror-symmetric subcarriers interfere with each other.

To sum up, the main problem of the prior art is the inability of the DHT-OFDM system to diagonalize the circulant channel matrix. In this invention, by using the inherence of DHT matrix, a simple diagonalization processor (i.e., DPU) is added to the DHT-OFDM system. With the DPU, the DHT-OFDM system can diagonalize the channel matrix. Thus, the receiver can compensate the channel effect by the one-tap FEQ as the conventional DFT-OFDM does.

This invention relates to a DHT-OFDM system applicable to a 2D modulation. The DHT-OFDM system can diagonalize the circulant channel and also prevent the system mirror-symmetric subcarriers from interfering with each other.

One objective of this invention is to design a DHT-OFDM system that applies to the 2D modulation, diagonalizes the circulant channel matrix, and also increases the efficiency of bandwidth to prevent the subcarriers from interfering with each other. Another objective of this invention is to provide a DHT-OFDM transmitter or receiver that is compatible with the conventional DFT-OFDM system; namely, the DHT-OFDM according to this invention can work with DFT-OFDM together.

For the purpose mentioned above, this invention uses two real-valued IDHT/DHT transform processors in the DHT-OFDM transmitter or receiver for achievement of 2D modulation. A diagonalization processor (i.e., DPU) is added to the transmitter or receiver. The processor diagonalizes the circulant channel matrix for the system.

### The Improved DHT-OFDM System

The advancement of this invention is the improved DHT-OFDM system that transmits the 2D modulation signal, such as QAM, and also diagonalizes the circulant channel matrix. With this system, the multipath fading channel is diagonalized N discrete memoryless subchannels, which can be easily compensated by one-tap FEQ. The detailed structure of this invention is described below.

FIG. 1 shows a block diagram of a DHT-OFDM transmitter system 20 in this invention; the function of the QAM mapper 3 is to map each bit stream to a 2D QAM signal vector [symbol] = [symbol] ^{R}+j [symbol] ¹. To modulate the 2D QAM to N orthogonal subcarriers by using the IDHT, the multicarrier modulator is expressed as per-envelop format H+jĤ, where Ĥ is the Hilbert transform of H. It can be expressed as:

$$\hat{H} = \frac{1}{\sqrt{N}} ( S - C ) = - {J}_{N} H = - {H}^{′} \qquad ( 6 )$$

where H′=J_{N}H=HJ_{N}. Thus, in FIG. 1, after the real and imaginary parts of QAM signal fed into the IDHT multicarrier modulator in the per-envelop format, the in-phase and quadrature-phase sequences are given by:

$${ }_{x}^{{ρ}_{R}} + {j}_{x}^{{ρ}_{I}} = ( H + j \hat{H} ) \cdot ( \text{?} + \text{?} ) = ( \text{?} + \text{?} ) \cdot H \cdot ( \text{?} + \text{?} ) \\ \text{?} \text{indicates text missing or illegible when filed} \qquad ( 7 )$$

The objective of proposed DHT-OFDM system is to diagonalize the channel effect. In the reference [R3], it is inferred that there are two types of matrices that can be diagonalized by DHT: one is symmetric circulant matrix, and the other is J_{N} matrix multiplied by the skew-symmetric circulant matrix. For this purpose, another DPU 34 is added before or after the receiver DHT. Thus, the signal vector [symbol] in the receiver can be expressed as:

$$\begin{matrix}\begin{matrix} \text{?} = \text{?} ( \text{?} - \text{?} ) H \cdot \text{?} + \text{?} \\ = ( {D}_{1} + {jD}_{2} ) \cdot {X}^{ρ} + {W}^{ρ}\end{matrix} & ( 8 ) \\ \text{?} \text{indicates text missing or illegible when filed} & \end{matrix}$$

Let D=D₁+jD₂, then the equation (8) is expanded to obtain the matrices D₁ and D₂, as shown below.

$${D}_{1} = H \text{?} H + {HJ}_{N} \text{?} H = 2 \{ {Λ}_{{\tilde{A}}_{R}} \} - 2 𝒥 \{ {Λ}_{{\tilde{A}}_{I}} \} \\ \text{?} \text{indicates text missing or illegible when filed} \qquad ( 9 )$$

D₂=H(Ã_{I}+J_{N}Ã₁J_{N})H+HJ_{N}(Ã_{R-J}_{N}Ã_{R}J_{N})H=2 [symbol] {Λ_{Ã}_{_{I}}}+2 [symbol] {Λ_{Ã}_{_{R}}} (10)

From equations (9) and (10), it is apparent that the designed DPU1 and DPU2 in this invention can make the circulant channel matrix satisfy with the conditions of symmetry and skew-symmetric. In other words, the DHT-OFDM system can indeed make the channel matrix to be diagonalized. Thus, for one-tap FEQ 35, a zero-forcing (ZF) or minimum mean-square error (MMSE) coefficient as shown below can be used to compensate the channel effects.

$$\{ \begin{matrix}{E}_{ZF} = {D}^{- 1} \\ {E}_{MMSE} = {D}^{H} ( {DD}^{H} + \frac{{σ}_{w}^{2}}{{σ}_{x}^{2}} {I}_{N} )\end{matrix} \qquad ( 11 )$$

Further, the DHT-OFDM transmitter or receiver in this invention has another advantage of compatibility with a general DFT-OFDM transmitter or receiver. As shown in FIG. 3, the signal from the DFT-OFDM transmitter can be demodulated directly by the proposed DHT-OFDM receiver in this invention and does not need additional signal processing. It is because the circulant channel matrix can be diagonalized by the hybrid DFT-OFDM transmitter and DHT-OFDM receiver. To verify the channel diagonalized fact, the signal vector [symbol] ′ in the receiver shown in FIG. 3 can be expressed as:

$${ }_{Y}^{{ρ}_{′ R}} + {j}_{Y}^{{ρ}_{′ I}} = ( \text{?} + \text{?} ) H {\tilde{A}}_{C} F \cdot {X}^{ρ} + {W}^{ρ} \\ \text{?} \text{indicates text missing or illegible when filed} \qquad ( 12 )$$

Deriving equation (12) by the DHT properties, it can be show in equation (13) that the matrix D′ is a diagonal matrix:

D′=( [symbol] {Λ_{Ã}_{_{R}}−ℑ{Λ_{Ã}_{R}}−ℑ{Λ_{Ã}_{I}}− [symbol] {Λ_{Ã}_{_{I}}})+j( [symbol] Λ_{Ã}_{_{R}}}+ℑ{Λ_{Ã}_{_{R}}}+ [symbol] {Λ_{Ã}_{_{I}}}−ℑ{Λ_{Ã}_{_{I}}}) (13)

Similarly, in FIG. 4, the DHT-OFDM transmitter signal can also be demodulated by the DFT-OFDM receiver. The signal vector [symbol] ″ at the receiver in FIG. 4 can be expressed as:

$${{Y}^{ρ}}^{′′} = \text{?} \cdot {X}^{ρ} + {W}^{ρ} \\ \text{?} \text{indicates text missing or illegible when filed} \qquad ( 14 )$$

where matrix D″ is also a diagonal matrix as follows:

D″=( [symbol] {Λ_{AÃ}_{R}}+ℑ{Λ_{Ã}_{R}}−ℑ{Λ_{Ã}_{_{I}}}+ [symbol] {ΛÃ_{I}})+j(− [symbol] {Λ_{Ã}_{_{R}}}+ℑ{ΛÃ_{_{R}}}+ [symbol] {Λ_{Ã}_{_{I}}}+ℑ{Λ_{Ã}_{_{I}}}) (15)

From equation (13) and (15), it is apparent that the multipath channel matrix can be diagonalized when the proposed DHT-OFDM transceiver works with the conventional DFT-OFDM transceiver; namely, only the simple one-tap FEQ is required to compensate the channel effects. Therefore, this invention not only is available for the mentioned DHT-OFDM system, but also flexibly and easily works with the conventional DFT-OFDM transmitter.

To sum up, the main function of this invention is to increase the efficiency of bandwidth and prevent the subcarriers from interfering with each other. Further, the DHT-OFDM transmitter or receiver in this invention is compatible with the conventional DFT-OFDM; namely, the DHT-OFDM system in this invention works with the DFT-OFDM system.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

### REFERENCE

[R1] D. Wang, D. Liu, F. Liu, and G. Yue, “A novel DHT-based ultra-wideband system,” in Proc. ISCIT, October, 2005, vol. 1, pp. 672-675.
[R2] R. Merched, “On OFDM and single-carrier frequency-domain systems based on trigonometric transforms,” IEEE Trans. Signal Process., vol. 13, no. 8, pp. 473-476, August 2006.
[R3] G. Heinig and K. Rost, “Representation of Toeplitz-plus-Hankel matrices using trigonometric transformations with application to fast matrix-vector multiplication,” Linear Algebra Appl., vol. 275-276, pp. 225-248, 1998.

What is claimed is:

1. A DHT-based OFDM transmitter, comprising:
a quadrature amplitude modulation (QAM) mapper, mapping a bit stream to a 2D QAM signal vector [symbol] = [symbol] ^{R}+j [symbol] ^{I};
a multicarrier modulator, being connected to the QAM mapper and generating an OFDM modulation signal with multiple carriers; and a diagonalization processing unit (DPU), wherein a terminal is connected to the multicarrier modulator, the DPU comprising a component J_{N}, in which the component J_{N} arranges a signal vector element in a retrograde order, and the DPU processes a modulated signal after the multicarrier modulator to make a circulant channel matrix be diagonalized.

2. The DHT-based OFDM transmitter according to claim 1, wherein the multicarrier modulator comprises two inverse discrete Hartley transform (IDHT) processors, and the IDHT modulates the 2D QAM signal [symbol] onto the N orthogonal subcarriers.

3. The DHT-based OFDM transmitter according to claim 1, wherein the other terminal of the DPU is connected to a terminal of a P/S and CP adding unit.

4. The DHT-based OFDM transmitter according to claim 3, wherein the other terminal of the P/S and CP adding unit is connected to a terminal of a D/A converter.

5. The DHT-based OFDM transmitter according to claim 4, wherein the other terminal of the D/A converter is connected to a terminal of a transmitter RF circuit and the other terminal of the transmitter RF circuit is further connected to a multipath fading channel.

6. A DHT-based OFDM receiver, comprising
a multicarrier demodulator, being used to demodulate the OFDM signal;
a diagonalization processing unit (DPU), being connected to the multicarrier demodulator and being used to make a DHT-OFDM receiver diagonalize a circulant channel matrix;
a one-tap frequency-domain equalizer, being connected to the DPU and being used to compensate channel effect on each subcarriers; and
a quadrature amplitude modulation (QAM) de-mapper, being connected to the one-tap frequency-domain equalizer and mapping a compensated QAM symbol to a bit stream.

7. The DHT-based OFDM receiver according to claim 6, wherein the multicarrier demodulator comprises two discrete Hartley transform (DHT) processors.

8. The DHT-based OFDM transmitter according to claim 7, wherein one terminal of the multicarrier modulator is further connected to a terminal of an S/P and a CP removing unit.

9. The DHT-based OFDM transmitter according to claim 8, wherein the other terminal of the P/S and CP removing unit is connected to a terminal of a D/A converter.

10. The DHT-based OFDM transmitter according to claim 9, wherein the other terminal of the A/D converter is connected to a terminal of a receiver RF circuit.

11. The DHT-based OFDM transmitter according to claim 10, wherein the other terminal of the receiver RF circuit is connected to a multipath fading channel.
